(19) United States
(12) Patent Application Publication
(10) Pub. No.: US 2025/0202548 A1
(43) Pub. Date: Jun. 19, 2025

(54) APPLYING A PRECODER TRANSFORM USING TIME-DOMAIN FILTERING AND SPREADING IN A WIRELESS COMMUNICATIONS SYSTEM

(71) Applicant: Lenovo (United States) Inc., Morrisville, NC (US)

(72) Inventors: Razvan-Andrei Stoica, Witten (DE); Ali Ramadan Ali, Kraiburg am Inn (DE); Karthikeyan Ganesan, Nauheim (DE)

(21) Appl. No.: 19/065,895

(22) Filed: Feb. 27, 2025

(51) Int. Cl. H04B 7/0456; H04L 5/00; H04L 27/26

(52) U.S. Cl. CPC H04B 7/0456; H04L 5/0005; H04L 27/2636

(57) ABSTRACT

Various aspects of the present disclosure relate to methods, apparatuses, and devices for wireless communication. A transmitter entity may be configured to, capable of, or operable to determine a first precoder transform for two sets of symbols. The transmitter entity may be configured to, capable of, or operable to map the two sets of symbols to an input sequence of symbols corresponding to at least one transmission layer and a set of physical transmission resources. The transmitter entity may be configured to, capable of, or operable to apply the first precoder transform to the input sequence of symbols by performing a time-domain extension filtering and spreading of the input sequence of symbols onto a set of frequency carriers as the set of physical transmission resources. The transmitter entity may be configured to, capable of, or operable to modulate the set of frequency carriers using a second transform.

### TECHNICAL FIELD

The present disclosure relates to wireless communications, and more specifically to applying a precoder transform using time-domain filtering and spreading in a wireless communications system.

### BACKGROUND

A wireless communications system may include one or multiple network communication devices, which may be known as a network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Various aspects of the present disclosure relate to wireless communications, including improved network entities, processors, and methods for applying a precoder transform using time-domain filtering and spreading in a wireless communications system.

A transmitter entity for wireless communication is described. The transmitter entity may be configured to, capable of, or operable to determine a first precoder transform for two sets of symbols. A first set of symbols of the two sets of symbols is generated by an information source as information symbols. The transmitter entity may be configured to, capable of, or operable to map the two sets of symbols to an input sequence of symbols corresponding to at least one transmission layer and a set of physical transmission resources. The transmitter entity may be configured to, capable of, or operable to apply the first precoder transform to the input sequence of symbols by performing a time-domain extension filtering and spreading of the input sequence of symbols onto a set of frequency carriers as the set of physical transmission resources. The transmitter entity may be configured to, capable of, or operable to modulate the set of frequency carriers using a second transform to generate a waveform signal. The transmitter entity may be configured to, capable of, or operable to transmit the waveform signal to a receiver entity.

A processor for wireless communication is described. The processor may be configured to, capable of, or operable to determine a first precoder transform for two sets of symbols. A first set of symbols of the two sets of symbols is generated by an information source as information symbols. The processor may be configured to, capable of, or operable to map the two sets of symbols to an input sequence of symbols corresponding to at least one transmission layer and a set of physical transmission resources. The processor may be configured to, capable of, or operable to apply the first precoder transform to the input sequence of symbols by performing a time-domain extension filtering and spreading of the input sequence of symbols onto a set of frequency carriers as the set of physical transmission resources. The processor may be configured to, capable of, or operable to modulate the set of frequency carriers using a second transform to generate a waveform signal. The processor may be configured to, capable of, or operable to transmit the waveform signal to a receiver entity.

A method performed or performable by a transmitter entity for wireless communication is described. The method may include determining a first precoder transform for two sets of symbols. A first set of symbols of the two sets of symbols is generated by an information source as information symbols. The method may include mapping the two sets of symbols to an input sequence of symbols corresponding to at least one transmission layer and a set of physical transmission resources. The method may include applying the first precoder transform to the input sequence of symbols by performing a time-domain extension filtering and spreading of the input sequence of symbols onto a set of frequency carriers as the set of physical transmission resources. The method may include modulating the set of frequency carriers using a second transform to generate a waveform signal. The method may include transmitting the waveform signal to a receiver entity.

A receiver entity for wireless communication is described. The receiver entity may be configured to, capable of, or operable to receive a waveform signal from a transmitter entity. The waveform signal corresponds to two sets of symbols arranged in an input sequence of symbols. A first set of symbols of the two sets of symbols is generated by an information source as information symbols. The receiver entity may be configured to, capable of, or operable to demodulate the waveform signal to frequency-domain samples using a third transform and equalizing transmission effects of the frequency-domain samples. The receiver entity may be configured to, capable of, or operable to receive a configuration comprising information of at least a first transform and a second set of symbols of the two sets of symbols. The first transform corresponds to a first precoder transform applied at the transmitter as a non-square linear transform. The non-square linear transform takes as inputs a number of time-domain samples larger than the number of spread frequency-domain outputs. The receiver entity may be configured to, capable of, or operable to apply the configuration information to cancel from the first set of symbols residual interference of a signal component corresponding to the second set of symbols and to generate a signal component corresponding to the first set of symbols. The receiver entity may be configured to, capable of, or operable to perform detection and estimation on the signal component to recover the information symbols.

A processor for wireless communication is described. The processor may be configured to, capable of, or operable to receive a waveform signal from a transmitter entity. The waveform signal corresponds to two sets of symbols arranged in an input sequence of symbols. A first set of symbols of the two sets of symbols is generated by an information source as information symbols. The processor may be configured to, capable of, or operable to demodulate the waveform signal to frequency-domain samples using a third transform and equalizing transmission effects of the frequency-domain samples. The processor may be configured to, capable of, or operable to receive a configuration comprising information of at least a first transform and a second set of symbols of the two sets of symbols. The first transform corresponds to a first precoder transform applied at the transmitter as a non-square linear transform. The non-square linear transform takes as inputs a number of time-domain samples larger than the number of spread frequency-domain outputs. The processor may be configured to, capable of, or operable to apply the configuration information to cancel from the first set of symbols residual interference of a signal component corresponding to the second set of symbols and to generate a signal component corresponding to the first set of symbols. The processor may be configured to, capable of, or operable to perform detection and estimation on the signal component to recover the information symbols.

A method performed or performable by a receiver entity for wireless communication is described. The method may include receiving a waveform signal from a transmitter entity. The waveform signal corresponds to two sets of symbols arranged in an input sequence of symbols. A first set of symbols of the two sets of symbols is generated by an information source as information symbols. The method may include demodulating the waveform signal to frequency-domain samples using a third transform and equalizing transmission effects of the frequency-domain samples. The method may include receiving a configuration comprising information of at least a first transform and a second set of symbols of the two sets of symbols. The first transform corresponds to a first precoder transform applied at the transmitter as a non-square linear transform. The non-square linear transform takes as inputs a number of time-domain samples larger than the number of spread frequency-domain outputs. The method may include applying the configuration information to cancel from the first set of symbols residual interference of a signal component corresponding to the second set of symbols and to generate a signal component corresponding to the first set of symbols. The method may include performing detection and estimation on the signal component to recover the information symbols.

### BRIEF DESCRIPTION OF THE DRAWINGS

FIG. 1 illustrates an example of a wireless communications system in accordance with aspects of the present disclosure.

FIG. 2 illustrates an example of an extended orthogonal frequency division multiplexing (OFDM) and discrete Fourier transform (DFT)-spread-OFDM (DFT-S-OFDM) (EDFT-S-OFDM) transceiver in accordance with aspects of the present disclosure.

FIG. 3 illustrates an example of a non-square transform precoder based on an N+P-point DFT precoding in accordance with aspects of the present disclosure.

FIG. 4 illustrates an example of an EDFT-S-OFDM receiver baseband chain processing of the EDFT-S-OFDM in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of a NE in accordance with aspects of the present disclosure.

FIG. 8 illustrates a flowchart of a method performed by a transmitter entity in accordance with aspects of the present disclosure.

FIG. 9 illustrates a flowchart of another method performed by a receiver entity in accordance with aspects of the present disclosure.

### DETAILED DESCRIPTION

Some wireless communication systems, including one or more UEs, base stations, network entities, or the like may support various waveforms may be used for transmitting and/or receiving data. In some cases, selected waveforms may be inefficient, such as using increased signaling overhead and power consumption. By way of example, some wireless communication systems may transmit and/or receive data having a high peak-to-average-power ratio (PAPR), resulting in higher use of resources (e.g., system bandwidth) and increased power consumption.

Various aspects of the present disclosure relate to enabling one or more UEs, base stations, network entities, or the like to support improvements to reducing a PAPR. In some examples, one or more UEs, base stations, network entities, or the like may be configured to apply a precoder transform to an input sequence of symbols by performing a time-domain extension filtering and spreading of the input sequence of symbols onto a set of frequency carriers as a set of physical transmission resources (e.g., time-frequency resources, resource elements (REs), resource blocks (RBs), downlink physical channels, uplink physical channels, etc.). Additionally, or alternatively, one or more UEs, base stations, network entities, or the like may be configured to communicate (e.g., transmit, output, indicate) a waveform with a reduced PAPR. By reducing the PAPR, one or more UEs, base stations, network entities, or the like may experience reduced power consumption, decreased processor usage, reduce data usage, and increase overall system performance.

Aspects of the present disclosure are described in the context of a wireless communications system.

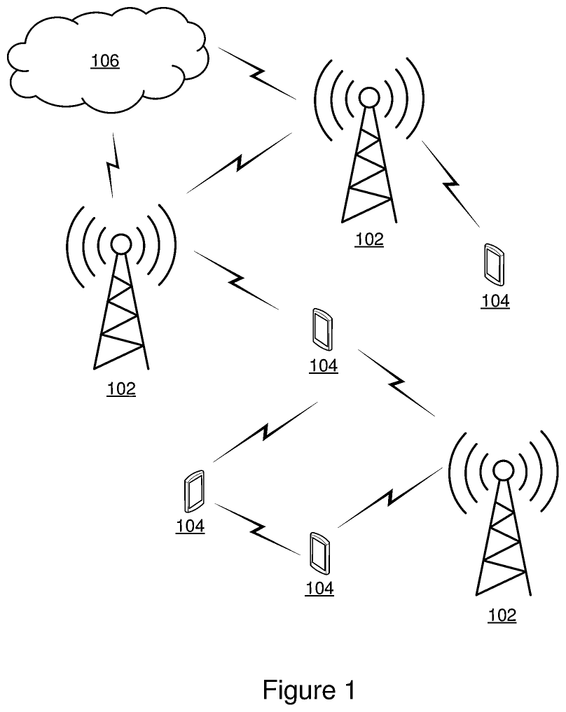

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with an NTN. In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a UE-to-UE interface (PC5 interface).

An NE 102 may support communications with the CN 106, or with another NE 102, or both. For example, an NE 102 may interface with other NE 102 or the CN 106 through one or more backhaul links (e.g., S1, N2, N3, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N3, N6 or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Good and wide-area coverage may be used for cellular communications systems. Wide-spread coverage may be attained by multiple enablers yet doing so while achieving high spectral efficiency and power efficiency may be both a technical and economic interests (e.g., lowering energy costs while delivering superior communications service). A key technical enabler may include a waveform design used by the communications system to transmit and receive information symbols over an air interface.

Cellular communications systems (e.g., like 4G LTE and 5G NR) may rely on DFT-S-OFDM waveforms for realizing coverage targets with increased spectral efficiency. However, coverage enhancements may be used to improve coverage and/or energy efficiency for both downlink (DL) and uplink (UL). On the network side, this may benefit a contained deployment of base station sites with potential for improved overall energy efficiency for next-generation cellular communications systems, such as 6G and the alike. On the UE side, battery life improvements and better UL performance may be issues of great interest and in need of further benefits. Nonetheless, achieving this in a backwards-compatible manner, or in a manner that does not require a complete hardware overhaul, or re-design thereof is of commercial and technical interest for a cellular communications ecosystem, i.e., equipment (i.e., infrastructure, UE, chipset) vendors, and Mobile Network Operators (MNOs).

Certain configurations may use waveform design with a low PAPR, including transceiver design and communications methods for coverage enhancements. Such configurations may enhance 4G LTE/5G NR waveforms, i.e., OFDM and DFT-S-OFDM, while benefitting increased coverage potential and/or energy savings by means of further reducing PAPR of emitted over-the-air physical radio communications signals.

In 5G NR, Cyclic Prefix (CP) OFDM (CP-OFDM) based waveform may be used for DL as well as for UL (e.g., in a multi-carrier format). Additionally, DFT-s-OFDM may be used for UL (e.g., in single carrier format).

CP-OFDM performance may have a degradation in power amplifier (PA) efficiency due to a high PAPR impinging the need for backoff at a transmitter (Tx) which may limit achievable coverage. DFT-S-OFDM may reduce the OFDM PAPR by spreading modulation symbols onto frequency resources at an input stage of a OFDM modulator. In effect, this spreading may act as a complex-valued shaping filter similar to a single-carrier waveform, thus constraining the PAPR after OFDM modulation. This may benefit PA efficiency reducing the need for backoff at the Tx. However, since network energy saving (NES), overall system energy efficiency and UL/DL coverage extensions are expected to be among important features of a 6G system, adopting low-PAPR waveforms beyond capabilities of DFT-s-OFDM may bring practical advantages for next-gen cellular communications.

A transform-based method may be used to reduce PAPR. The transform may be based on extending a DFT precoder in the DFT-S-OFDM and may generate an EDFT-S-OFDM. The extension on the DFT precoder may be performed over time domain inputs while the frequency domain outputs may be preserved. The extension plays a dual role, first modifying (i.e., by time-domain oversampling, or alternatively, time-domain extension) for lower PAPR the single-carrier shaping filter associated with the DFT-S-OFDM waveform, and second enhancing the degrees of freedom of the input space for creating time domain sequences that may generate low PAPR. The second component of extra degrees of freedom gained by the time extension may be leveraged in some embodiments by a PAPR reduction reference sequence (RS), or, alternatively, a PAPR reduction reference signal, which may be used to optimize PAPR to a lower value either dynamically, i.e., as a function of the varying information symbols, or semi-statically, based on a pre-determined set of PAPR reduction RS configuration.

The EDFT-S-OFDM waveform may result in a new transform-based single-carrier waveform preserving key underlying properties of DFT-S-OFDM yet may be beneficial for delivering lower PAPR and improved coverage.

The transform realizing the EDFT-S-OFDM waveform may be applied in a conjugate transpose form at a receiver, or alternatively as a matched filter, to detect and recover an information signal carried and transmitted over EDFT-S-OFDM. Depending on the design of the time-domain input sequence and the way the extra degrees of freedom are leveraged, receivers may require further interference cancellation of non-information signals, i.e., PAPR reduction reference signals, or time domain sequences used to further reduced the PAPR over the associated EDFT-S-OFDM waveforms.

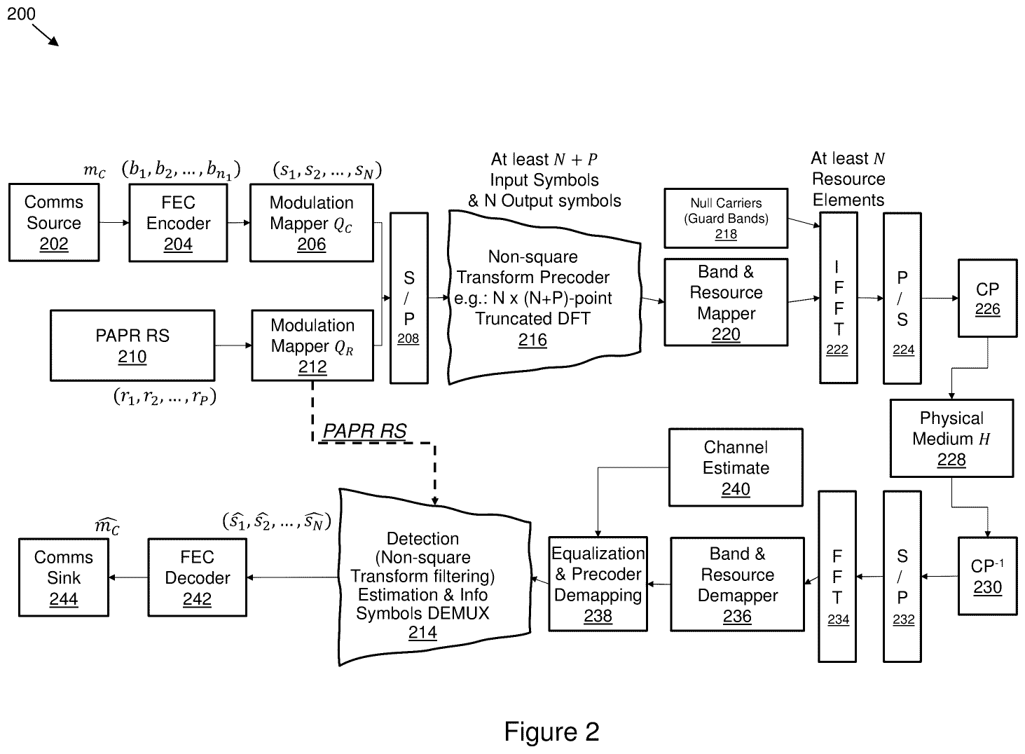

An overview of the EDFT-S-OFDM is presented in FIG. 2. At a transmitter side there is a non-square transform precoder (e.g., based on DFT) expanding (or extending) the time domain sequence spread over the resource elements of the OFDM modulator, and a PAPR reduction RS as a set of known time-domain symbols used to further exploit the time domain expansion guaranteed degrees of freedom for waveform design and optimize PAPR gains over DFT-S-OFDM. At a receiver side there is a non-square transform precoder (e.g., conjugate transpose form of the transmitted non-square transform) used as part of the symbol detection, estimation and demultiplexing filter for retrieving the transmitted input symbols prior to channel decoding.

FIG. 2 illustrates an example of an EDFT-S-OFDM transceiver 200 in accordance with aspects of the present disclosure. The EDFT-S-OFDM transceiver 200 includes a common source block 202, a forward error correction (FEC) encoder block 204, a first modulation mapper block ( [symbol] c) 206, an serial(S)/parallel (P) block 208, a PAPR RS block 210, a second modulation mapper block ( [symbol] _{R}) 212, a detection block 214, a non-square transform precoder block 216, null carriers block 218, a band and resource mapper block 220, an IFFT block 222, a P/S block 224, a CP block 226, a physical medium block 228, a CP⁻¹ block 230, an S/P block 232, a FFT block 234, a band and resource demapper block 236, an equalization and precoding demapping block 238, a channel estimate block 240, an FEC decoder block 242, and a common sink block 244.

In one configuration, a transmitter may include the non-square transform precoder block 216 for inputs s_{N}=(s₁, s₂, . . . , s_{N}) directed to an OFDM modulator with the inputs sampled using a discrete constellation mapping Q_{C}. The non-square transform precoder block 216 may apply to time domain discrete input information symbols selected out of a discrete I/Q constellation alphabet, such as binary phase-shift keying (PSK) (BPSK), QPSK/4-quadrature amplitude modulation (QAM), M-QAM or the like, including any data-driven constellation alphabets. In such configurations, the non-square transform precoder extends the input space of the input information symbols, e.g., time-domain samples thereof, e.g., s₁, s₂, . . . , s_{N}. The extension of the input space may provide additional sample locations that may be filled and filtered jointly, or jointly processed alongside the information input symbols. The extension mechanism may be facilitated by the non-square transform input/output linear mapping, whereas N+P input elements are spread to form N output elements, such that P>0.

In some configurations, applying the precoder non-square transform block 216 may include determining its time-domain input samples by allocating, to the extended time domain, samples of other symbols alongside the information symbols s_{N}=(s₁, s₂, . . . , s_{N}). This operation may involve joint S/P 208 transform of the input information symbols s_{N}=(s₁, s₂, . . . , s_{N}) with the additional symbols r_{P}=(r₁, r₂, . . . , r_{P}) to form the sample vector (or sequence) to the precoder non-square transform input stage. This step may involve a symbol mapper pre-or during serial-to-parallel conversion, or an interleaver (e.g., a permutation interleaver) post-serial-to-parallel conversion that maps the samples to the input stage locations of the non-square transform precoder, e.g., ^{˜}s_{N+P}=(^{˜}s₁, ^{˜}s₂, . . . ^{˜}s_{N}, ^{˜}s_{N+1}, ^{˜}s_{N+2}, . . . , ^{˜}s_{N+P}). In one configuration, these additional symbols may be referred to as PAPR reduction reference sequence, reference symbols, or PAPR reduction symbols. In some configurations, the PAPR reduction symbols may be known as fixed and/or configured semi-statically by upper radio control layers for the transmitter for one or more input information symbols sequences s_{N}. For instance, in one example these may be NULLED, assigned the value ‘0’. In another example, these may be assigned a time-domain sequence r_{P}=(r₁, r_{2 2}, . . . , r_{P}) selected to reduce the PAPR of the resulting waveform for a given radio configuration, depending on OFDM radio parameters such as: sub-carrier spacing (SCS), available transmission bandwidth (BW), e.g., expressed in number of resource blocks (RBs), or resource elements (REs), size of the OFDM modulator IFFT transform, values of N, P and/or ρ (following the notation introduced herein, i.e.,

$$ρ = \frac{P}{N} ) ,$$

modulation order, number of MIMO layers/ports active, etc. In some configurations, these PAPR reduction reference sequences may be sampled from discrete constellation alphabets Q_{R}, wherein Q_{R} may be the same as Q_{C}, or Q_{R} may be a completely different constellation alphabet than Q_{C} (i.e., the constellation alphabet corresponding to the information symbols). In various configurations, such constellation alphabets may be dynamically derived based on the input information symbols. The input information symbols may be transformed and/or mapped in part or fully to form PAPR reduction symbols, whereas the transform and/or mapping may be fixed for a transmitter realization, or for a transmitter operation point realization (i.e., depending on OFDM radio parameters such as: SCS, available transmission BW, e.g., expressed in number of RBs, or REs, size of the OFDM modulator IFFT transform, values of N and/or P (following the notation introduced above), modulation order, number of MIMO layers/ports active, etc.).

In one configuration, the S/P 208 conversion step may be combined with the dynamic determination of PAPR reduction symbols based on input information symbols. This may generate a particular pattern (e.g., repetition at the end, repetition at the beginning, repetition at both beginning and end, cyclic patterns, etc.) of input information symbols, or conjugate thereof, mapped to sample positions corresponding to PAPR reduction symbols. Some example realizations of such dynamic mapping and determination of the PAPR reduction symbols based on the input information symbols may include:
1). A mapping in which one of first or last P symbols of ¹⁸ s_{N+P} are PAPR reduction symbols r_{P} which may be mapped to be one of the same values as the first or last P symbols of s_{N}.
2). A mapping in which one of first or last P symbols of ^{˜}s_{N+P} are PAPR reduction symbols r_{P} which may be mapped to be one of the same as conjugate values of the first or last P symbols of s_{N}.
3). A mapping in which one of first or last P symbols of ^{˜}s_{N+P} are PAPR reduction symbols r_{P} which may be mapped to be one of same as I/Q quadrant-mirrored values of the first or last P symbols of s_{N}. The mirroring may be performed against in-phase and/or quadrature components of the first or last P symbols of s_{N}.
4). A mapping in which both first ceil (P/2) (or floor (P/2)) and last floor (P/2) (or ceil (P/2)) (or similar combinations) symbols of ^{˜}s_{N+P} are PAPR reduction symbols r_{P} which may be mapped to be one of the same values as first ceil (P/2) (or floor (P/2)) and last floor (P/2) (or ceil (P/2)) (or similar combinations) symbols of s_{N}.
5). A mapping in which both first ceil (P/2) (or floor (P/2)) and last floor (P/2) (or ceil (P/2)) (or similar combinations) symbols of ^{˜}s_{N+P} are PAPR reduction symbols r_{P} which may be mapped to be one of the same as conjugate values of first ceil (P/2) (or floor (P/2)) and last floor (P/2) (or ceil (P/2)) (or similar combinations) symbols of s_{N}.
6). A mapping in which both first ceil (P/2) (or floor (P/2)) and last floor (P/2) (or ceil (P/2)) (or similar combinations) symbols of ^{˜}s_{N+P} are PAPR reduction symbols r_{P} which may be mapped to be one of the same as I/Q quadrant-mirrored values of first ceil (P/2) (or floor (P/2)) and last floor (P/2) (or ceil (P/2)) (or similar combinations) symbols of sj_{N}. Such cyclic patterns may be useful as follows:
i). firstly, they provide robust PAPR reduction performance;

ii). secondly, they provide simple dynamic pattern and PAPR reduction symbols rules universally applicable to any I/Q constellation alphabet and any input symbol sequence; and/or
iii). thirdly, they simplify and improve detection performance at the receiver side exploiting the degrees of freedom at the input stage of the non-square transform to not only improve PAPR but also improve reliability by repetition and spreading gains.

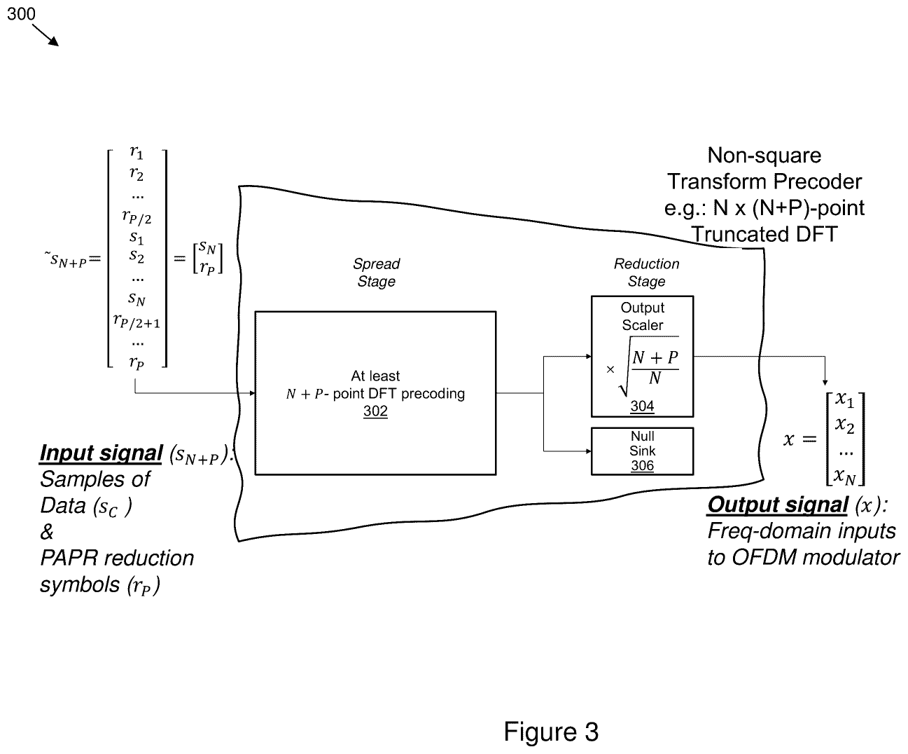

In some configurations, the non-square precoder transform block 216 described insofar and depicted briefly at the transmitter side of the transceiver in FIG. 2 may be realized based on an N+P-point DFT transform. The N+P-point DFT transform may be truncated at the output stage and rescaled to balance off the truncation power penalty in the output samples generated. An example configuration displays, in FIG. 3, the realization of the non-square transform precoder block 216 as a N+P-point DFT transform and its two processing stages. In opposition to a simple N+P-point DFT transform undergoing only spreading of symbols onto the frequency resources of the OFDM modulator, the precoder may have a first spreading stage performing the DFT transform, followed by a second reduction stage. The reduction stage may essentially implement the time-domain expansion by reducing the frequency domain representation, or performing spectral compression/spectral reduction. The spectral compression/spectral reduction may correspond to eliminating (or truncating) P outputs of the first spreading stage from the output of the DFT. In one example, realization this operation may be performed by discarding (e.g., to a NULL sink) P outputs of the DFT results after the first stage, as shown in FIG. 3. In addition, as the spectral compression/spectral reduction affects the power properties of the resultant (N+P)×N-DFT truncated transform, concomitantly the reduction stage includes a power re-balancing by rescaling the outputs of the original DFT by the factor \sqrt{N+P}/\sqrt{N}. The latter may ensure power unit-normalization properties post-application of the precoder to generate the output vector x_{N}=(x₁, x₂, . . . , x_{N}) as input to the OFDM modulator to generate the OFDM symbols:

$${y}_{n} = \frac{1}{\sqrt{N}} {\sum }_{k = 0}^{N - 1} {x}_{k} exp ( \frac{j 2 π}{N} kn ) = \frac{1}{\sqrt{N}} {\sum }_{k = 0}^{N - 1} {\sum }_{m = 0}^{N + P - 1} {}^{\sim} {s}_{m} exp ( - \frac{j 2 π}{N + P} mk ) exp ( \frac{j 2 π}{N} kn ) = {\sum }_{m = 0}^{N + P - 1} {}^{\sim} {s}_{m} {g}_{( 1 + ρ ) n - m}$$

where

$$1 + ρ = \frac{N + P}{N} ,$$

and ρ or alternatively P parameterize the equivalent time-domain single-carrier waveform shaping filter [symbol] _{(1+ρ)n=m}. The time-expansion complex filter [symbol] _{(1+ρ)n-m} is an abridged notation of

$${g}_{( 1 + ρ ) n - m} = {\sum }_{k = 0}^{N - 1} \frac{1}{\sqrt{N}} exp ( - \frac{j 2 π}{N ( 1 + ρ )} \cdot ( ( 1 + ρ ) n - m ) ) .$$

The described transmitter structure is illustrated in FIG. 3 and may be implemented by 4G LTE and 5G NR transmitters with small additional changes, i.e., DFT truncation and rescaling, relative to existing implementations, without necessitating expensive specialized application-specific integrated circuit (ASIC) hardware development or investment.

FIG. 3 illustrates an example of a non-square transform precoder block 300 based on an N+P-point DFT precoding in accordance with aspects of the present disclosure. The non-square transform precoder block 300 includes a DFT precoding block 302, an output scaler block 304, and a null sink block 306.

In some configurations, the filtering described herein may lead to a novel carrier waveform with single-carrier characteristics, such as improved PAPR, by means of time expansion/time extension (or spectral reduction) based on a non-square truncated DFT-S-OFDM precoder. Given the inherent time extension/time expansion of the precoding filtering, such waveforms and modulation systems may be called EDFT-S-OFDM. In other configurations, the EDFT-S-OFDM waveforms and/or modulation systems may be parameterized and configured based on their ρ, or P parameters. The parameter ρ may quantify the time expansion/time extension ratio relative to the transform precoder dimensionality ratio. P represents an alternative absolute representation thereof. As per the impact of the complex-domain filter [symbol] _{(1+ρ)n-m}, the parameter ρ may impact the spectral shaping and PAPR reduction potential of the EDFT-S-OFDM system. In some configurations, an EDFT-S-OFDM modulation system may be further configured, e.g., by upper radio control layers, to operate at a fixed ρ for a specific operation configuration, e.g., SCS, available transmission BW, e.g., expressed in number of RBs, or alternatively, REs, size of the OFDM modulator IFFT transform, modulation order, number of MIMO layers/ports active, etc., or combination thereof.

There may be PAPR reduction gain for a radio configuration corresponding to 5 MHz BW at 15 kHz SCS with 25 RBs and an OFDM IFFT size of 512 typical for 4G LTE and/or 5G NR radio configurations. The effective DFT precoder size for DFT-S-OFDM waveform may be 300×300 and the effective non-square DFT precoder size for the EDFT-S-OFDM waveform may be 360×300 with ρ=0.2. PAPR gains against deployed practical schemes, DFT-S-OFDM and OFDM may be obtained with improvements of ˜2.4 dB for BPSK, ˜1.5 dB for 4-QAM and ˜1 dB for 16-QAM over DFT-S-OFDM PAPR.

In certain configurations, the EDFT-S-OFDM waveform may be shaped and/or filtered before transmission by additional shaping filters, e.g., a spectral shaping filter, a single carrier shaping filter or combinations thereof.

In some configurations, the EDFT-S-OFDM waveform carrying both information symbols and PAPR reduction symbols may be transmitted over a physical medium to a receiver node. In certain configurations, the receiver node receives an analog signal over a physical medium, applies down-conversion, filtering, and digitizes the received signal for baseband, or intermediate frequency processing. In one configuration, the filtering step may be a precursor of the digital-to-analog conversion, a successor of the digital-to-analog conversion, or a combination thereof. Furthermore, in some configurations, the filtering may include passband filtering (i.e., low-pass, bandpass, high-pass filtering), carrier phase and timing synchronization, MIMO combining and processing, or any combination thereof to maximize the received signal SNR and prepare it for baseband processing and symbol detection.

In one configuration, an EDFT-S-OFDM waveform baseband receiver processing includes the detection and decoding of input information symbols s_{N}. In some configurations, e.g., when PAPR reduction symbols are not NULL, i.e., ‘0’ valued, the receiver baseband processing may require interference cancellation of PAPR reduction symbols for robust detection and decoding of the input information symbols in the baseband received signal y. Consider without loss of generality the non-square transform precoder of EDFT-S-OFDM, i.e., the N×(N+P) truncated and rescaled DFT be denoted as W, while denoting by D_{N} the canonical N-point FFT. The received baseband signal may include at least the effects of the OFDM demodulation, the physical medium, the OFDM modulation and the receiver side baseband noise. Given the circular channel convolution matrix DFT factorization, the baseband frequency-domain signal, after the FFT of the OFDM demodulator, demodulation may be represented as:

$$Y = diag ( H ) \cdot ( {D}_{N} {D}_{N}^{H} ) \cdot x + {D}_{N} n = diag ( H ) W {}^{\sim} {s}_{N + P} + {D}_{N} n$$

wherein the at least N-point DFT D_{N} corresponds to the FFT transformation of the OFDM demodulator, the at least N-point DFT D_{N}^{H} corresponds to the IFFT transformation of the OFDM modulator, the diagonal matrix dia [symbol] (H) corresponds to the physical medium frequency response, the joint matrix D_{N}^{H}·dia [symbol] (H)·D_{N} represents the physical medium circulant discrete time convolution transform of the baseband modulated signal D_{N}^{H}·x, and D_{N}n is the outstanding noise component post-demodulation at the receiver. It follows that in some embodiments, the frequency domain processing of the received signal y is simplified to:

$$Y = diag ( H ) \cdot W {}^{\sim} {s}_{N + P} + {D}_{N} n$$

given the expansion of the EDFT-S-OFDM waveform input x=W·^{˜}s_{N+P} to the OFDM modulator input stage at the transmitter.

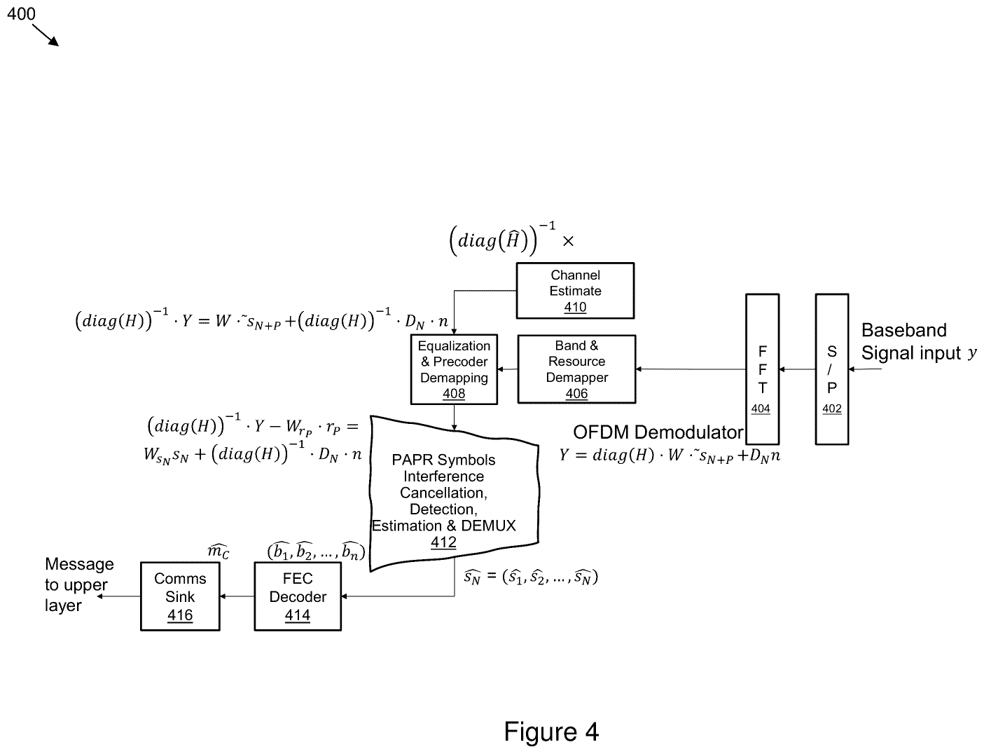

FIG. 4 illustrates an example of a EDFT-S-OFDM receiver block 400 baseband chain processing of the EDFT-S-OFDM in accordance with aspects of the present disclosure. The EDFT-S-OFDM receiver block 400 includes a S/P block 402, a FFT block 404, a band and resource demapper block 406, an equalization and precoder demapping block 408, a channel estimate block 410, a PAPR symbols interference cancellation, detection, estimation and demultiplexer (DEMUX) block 412, a FEC decoder block 414, and a common sink 416.

In some configurations, the physical medium one-tap frequency equalization by means of the channel inverse may be applied to generate an equivalent equalized representation:

$${( diag ( H ) )}^{- 1} \cdot Y = W \cdot {}^{\sim} {s}_{N + P} + {( diag ( H ) )}^{- 1} \cdot {D}_{N} \cdot n$$

for the detection of the symbols ^{˜}s_{N+P}.

In one configuration, the receiver may apply a prior knowledge of at least one of:
i). the pattern of ^{˜}s_{N+P} of the transmitted precoded vector samples (or time sequence);
ii). the PAPR reduction symbol r_{P} values (i.e., when fixed), or their relation/mapping to input information symbols, s_{N}, (i.e., when dynamically generated); and
iii). the non-square precoding transform W (e.g., the N×(N+P) truncated and rescaled DFT as introduced herein for EDFT-S-OFDM waveform),

to perform interference cancellation of the PAPR reduction symbols elements. The PAPR reduction symbol elements (e.g., the PAPR symbols interference cancellation, detection, estimation and DEMUX block 412) may need to be interference cancelled relative to the input information symbols, given the fact that by non-square nature of the transform W, it is not unitary and W′W≠I_{N+P} for the N+P time-extended, or time expanded input space.

In some configurations, the receiver is configured with prior knowledge of the PAPR reduction symbols r_{P} and of the precoding filter W used. This configuration may be setup in the receiver by a fixed implementation of EDFT-S-OFDM, by control signaling from an access network radio resource control (RRC) non-access stratum (NAS) messaging, or by a peer transmitter control signaling embedded at lower layers, such as MAC Control Elements (MAC-CE), Demodulation Reference Signals (DM-RSs), downlink control information (DCI), uplink control information (UCI), sidelink control information (SCI), or alike mechanisms and corresponding procedures. Given such knowledge of r_{P} and W, a receiver may implement a PAPR interference cancellation scheme (either in frequency domain or in time domain) to remove the PAPR reduction symbols for improving the SINR and detection and estimation of the input information symbols s_{N}. One example one-tap frequency domain interference cancellation approach for the case when r_{P} is fixed, such that:

$${( diag ( H ) )}^{- 1} \cdot Y - {W}_{{r}_{P}} \cdot {r}_{P} = {W}_{{s}_{N}} {s}_{N} + {( diag ( H ) )}^{- 1} \cdot {D}_{N} \cdot n$$

where W is correspondingly partitioned in Wᵣ_{_{P}} and Wₛ_{_{N}} (i.e., by selecting corresponding rows mapping to the positions mapped to the PAPR reduction symbols, and respectively, to the input information symbols at the input stage of the precoder W at the transmitter). The left-hand side signal vector (dia [symbol] (H))⁻¹·Y−Wᵣ_{_{P}}·r_{P} ∈ [symbol] ^{N×1} is the interference-free received signal corresponding to the non-square transform precoded input information symbols s_{N}. In some configurations, the left-hand side is used to estimate the symbols s_{N}, decode and recover input information which may be sent to upper layers for further processing. An example realization of described receiver embodiments herein is displayed in FIG. 4.

The control signaling may include control information elements, e.g., downlink control information (DCI), uplink control information (UCI), or other control envelopes (e.g., RRC control messages), that include signaling corresponding to at least determining the PAPR reduction symbols, or their mapping/relation to the input information symbols, and of the non-square precoder linear precoding W used at the transmitter.

In one configuration, the EDFT-S-OFDM receiver may apply matched filtering (e.g., by means of Wᵣ_{_{P}}^{H}, or alternatively, W^{H}, corresponding to the non-square linear precoder, W, used at the EDFT-S-OFDM transmitter), least squares filtering, linear minimum mean square filtering, any other linear-based detection filtering, non-linear detection filtering, or any combinations thereof to obtain and recover the input information symbols s_{N}. In one example, the receiver may apply first matched filtering by means of the subsampled precoder Wₛ_{_{N}}^{H} followed by parallelized Gaussian elimination taking advantage of the spectral structure of the Grammian operator Wₛ_{_{N}}^{H}Wₛ_{_{N}} which is symmetric with diagonal entries 1 by means of W construction constrained to unit-norm column vectors. In another example, the receiver may apply directly Gaussian elimination, or least squares on the invertible Wₛ_{_{N}}. In an alternate example, the receiver may apply linear minimum mean square filtering considering the noise variance and distribution post-demodulation, equalization, and sensing-signal interference cancellation. In other examples, the receiver may apply any non-linear data-driven learned receivers, whereas in some examples the latter may be applied in combination with any of the previous steps. In alternative examples, the receiver may optimize Gaussian elimination or any of the filters described above based on the pattern of the joint input sequence ^{˜}s_{N+P} including both input information symbols and PAPR reduction symbols, and on the dynamic mapping/relation between r_{P} and s_{N}.

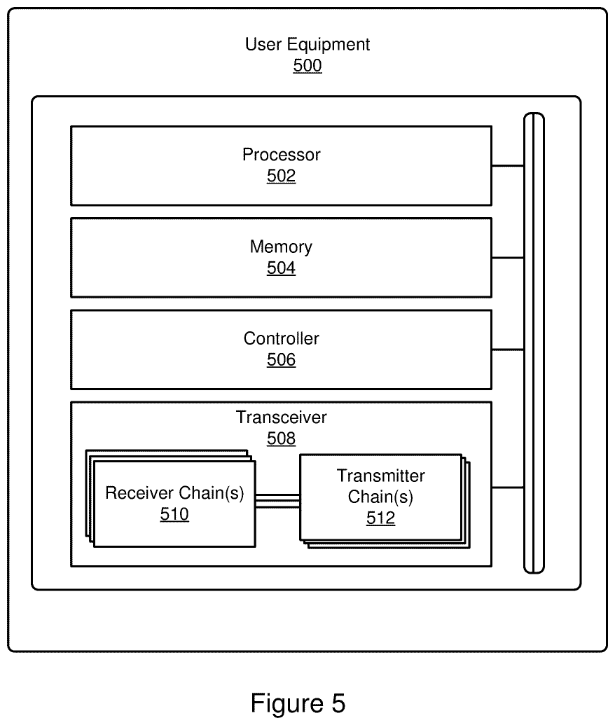

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an ASIC, or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, a field programmable gate array (FPGA), or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. For example, the processor 502 coupled with the memory 504 may be configured to cause the UE 500 to perform various actions described herein.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receive the signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like PSK or QAM. The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

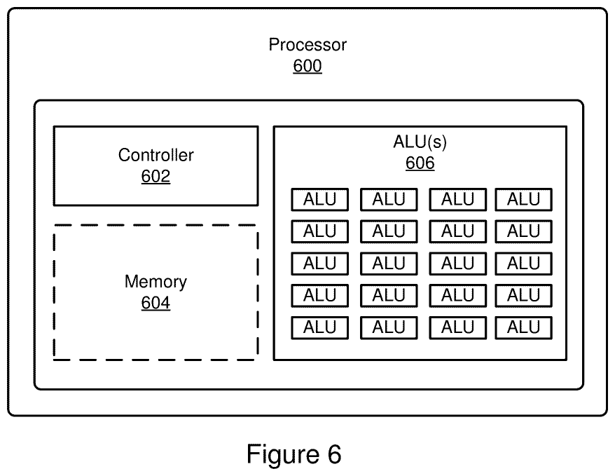

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support a means for performing various operations described herein. For example, the processor 600 may be configured to: determine a first precoder transform for two sets of symbols, wherein a first set of symbols of the two sets of symbols is generated by an information source as information symbols; map the two sets of symbols to an input sequence of symbols corresponding to at least one transmission layer and a set of physical transmission resources; apply the first precoder transform to the input sequence of symbols by performing a time-domain extension filtering and spreading of the input sequence of symbols onto a set of frequency carriers as the set of physical transmission resources; modulate the set of frequency carriers using a second transform to generate a waveform signal; and transmit the waveform signal to a receiver entity. Additionally, or alternatively, the processor 600 may be configured to receive a waveform signal from a transmitter entity, wherein the waveform signal corresponds to two sets of symbols arranged in an input sequence of symbols, and wherein a first set of symbols of the two sets of symbols is generated by an information source as information symbols; demodulate the waveform signal to frequency-domain samples using a third transform and equalizing transmission effects of the frequency-domain samples; receive a configuration comprising information of at least a first transform and a second set of symbols of the two sets of symbols, wherein the first transform corresponds to a first precoder transform applied at the transmitter as a non-square linear transform, and the non-square linear transform takes as inputs a number of time-domain samples larger than the number of spread frequency-domain outputs; apply the configuration information to cancel from the first set of symbols residual interference of a signal component corresponding to the second set of symbols and to generate a signal component corresponding to the first set of symbols; and perform detection and estimation on the signal component to recover the information symbols.

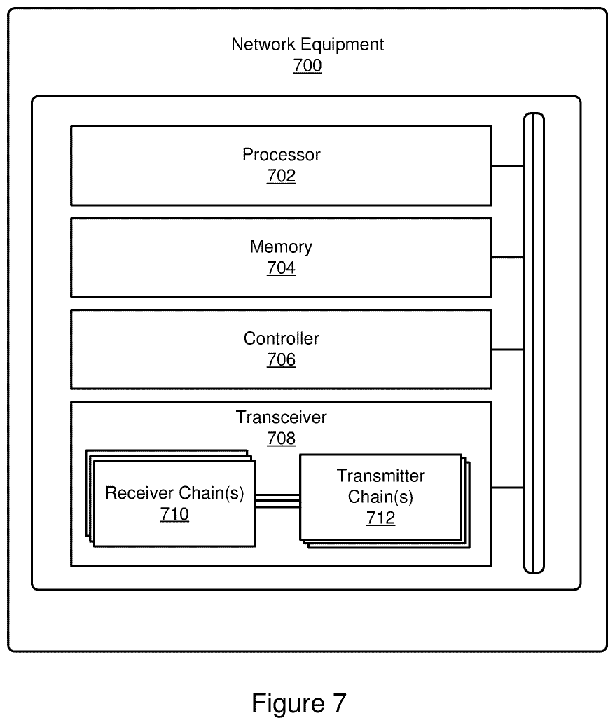

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an ASIC, or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure. For example, the processor 702 coupled with the memory 704 may be configured to cause the NE 700 (e.g., a transmitter entity) to: determine a first precoder transform for two sets of symbols, wherein a first set of symbols of the two sets of symbols is generated by an information source as information symbols; map the two sets of symbols to an input sequence of symbols corresponding to at least one transmission layer and a set of physical transmission resources; apply the first precoder transform to the input sequence of symbols by performing a time-domain extension filtering and spreading of the input sequence of symbols onto a set of frequency carriers as the set of physical transmission resources; modulate the set of frequency carriers using a second transform to generate a waveform signal; and transmit the waveform signal to a receiver entity. Additionally, or alternatively, the processor 702 coupled with the memory 704 may be configured to cause the NE 700 (e.g., a receiver entity) to receive a waveform signal from a transmitter entity, wherein the waveform signal corresponds to two sets of symbols arranged in an input sequence of symbols, and wherein a first set of symbols of the two sets of symbols is generated by an information source as information symbols; demodulate the waveform signal to frequency-domain samples using a third transform and equalizing transmission effects of the frequency-domain samples; receive a configuration comprising information of at least a first transform and a second set of symbols of the two sets of symbols, wherein the first transform corresponds to a first precoder transform applied at the transmitter as a non-square linear transform, and the non-square linear transform takes as inputs a number of time-domain samples larger than the number of spread frequency-domain outputs; apply the configuration information to cancel from the first set of symbols residual interference of a signal component corresponding to the second set of symbols and to generate a signal component corresponding to the first set of symbols; and perform detection and estimation on the signal component to recover the information symbols.

In some implementations, the request message includes a request to support a process. In some implementations, the process may include one or more operations, actions, tasks, or the like. In some implementations, the process comprises creating the group with one or more members. In some implementations, the group is created based at least in part on the request to support the process. In some implementations, the processor 702 coupled with the memory 704 may be configured to cause the NE 700 (e.g., a first NE) to evaluate the process and at least one requirement for selecting one or more members for the group. In some implementations, the group is created based at least in part on the evaluated process and the evaluated at least one requirement.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receive the signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

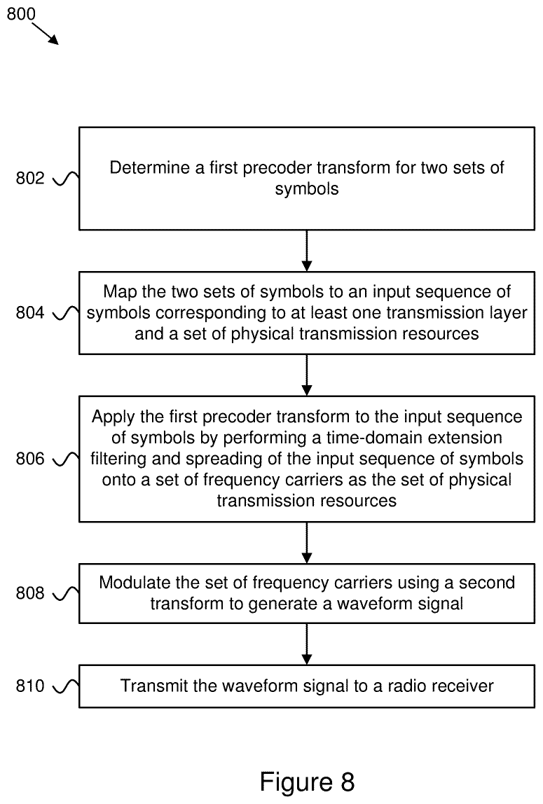

FIG. 8 illustrates a flowchart of a method 800 in accordance with aspects of the present disclosure. The operations of the method 800 may be implemented by a transmitter entity (e.g., in a UE or NE) as described herein. In some implementations, the transmitter entity may execute a set of instructions to control the function elements of a processor to perform the described functions. It should be noted that the method described herein describes a possible implementation, and that the operations and the steps may be rearranged or otherwise modified and that other implementations are possible.

At 802, the method may include determining a first precoder transform for two sets of symbols. The operations of 802 may be performed in accordance with examples as described herein. In some implementations, aspects of the operations of 802 may be performed by a UE as described with reference to FIG. 5 or a NE as described with reference to FIG. 7.

At 804, the method may include mapping the two sets of symbols to an input sequence of symbols corresponding to at least one transmission layer and a set of physical transmission resources. The operations of 804 may be performed in accordance with examples as described herein. In some implementations, aspects of the operations of 804 may be performed by a UE as described with reference to FIG. 5 or a NE as described with reference to FIG. 7.

At 806, the method may include applying the first precoder transform to the input sequence of symbols by performing a time-domain extension filtering and spreading of the input sequence of symbols onto a set of frequency carriers as the set of physical transmission resources. The operations of 806 may be performed in accordance with examples as described herein. In some implementations, aspects of the operations of 806 may be performed by a UE as described with reference to FIG. 5 or a NE as described with reference to FIG. 7.

At 808, the method may include modulating the set of frequency carriers using a second transform to generate a waveform signal. The operations of 808 may be performed in accordance with examples as described herein. In some implementations, aspects of the operations of 808 may be performed by a UE as described with reference to FIG. 5 or a NE as described with reference to FIG. 7.

At 810, the method may include transmitting the waveform signal to a receiver entity. The operations of 810 may be performed in accordance with examples as described herein. In some implementations, aspects of the operations of 810 may be performed by a UE as described with reference to FIG. 5 or a NE as described with reference to FIG. 7.

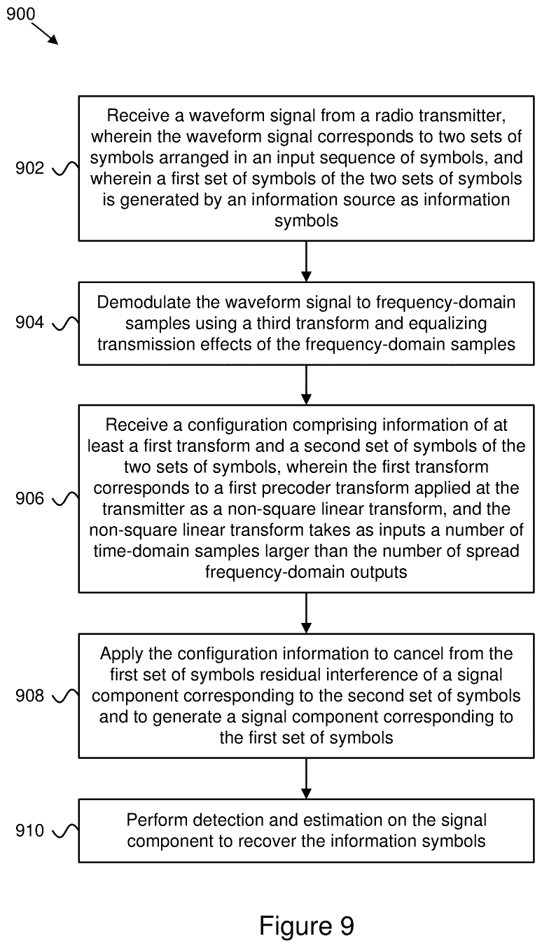

FIG. 9 illustrates a flowchart of another method 900 in accordance with aspects of the present disclosure. The operations of the method 900 may be implemented by a receiver entity (e.g., a UE, a NE) as described herein. In some implementations, the receiver entity may execute a set of instructions to control the function elements of a processor to perform the described functions. It should be noted that the method described herein describes a possible implementation, and that the operations and the steps may be rearranged or otherwise modified and that other implementations are possible.

At 902, the method may include receiving a waveform signal from a transmitter entity, wherein the waveform signal corresponds to two sets of symbols arranged in an input sequence of symbols, and wherein a first set of symbols of the two sets of symbols is generated by an information source as information symbols. The operations of 902 may be performed in accordance with examples as described herein. In some implementations, aspects of the operations of 902 may be performed by a UE as described with reference to FIG. 5 or a NE as described with reference to FIG. 7.

At 904, the method may include demodulating the waveform signal to frequency-domain samples using a third transform and equalizing transmission effects of the frequency-domain samples. The operations of 904 may be performed in accordance with examples as described herein. In some implementations, aspects of the operations of 904 may be performed by a UE as described with reference to FIG. 5 or a NE as described with reference to FIG. 7.

At 906, the method may include receiving a configuration comprising information of at least a first transform and a second set of symbols of the two sets of symbols, wherein the first transform corresponds to a first precoder transform applied at the transmitter as a non-square linear transform, and the non-square linear transform takes as inputs a number of time-domain samples larger than the number of spread frequency-domain outputs. The operations of 906 may be performed in accordance with examples as described herein. In some implementations, aspects of the operations of 906 may be performed by a UE as described with reference to FIG. 5 or a NE as described with reference to FIG. 7.

At 908, the method may include applying the configuration information to cancel from the first set of symbols residual interference of a signal component corresponding to the second set of symbols and to generate a signal component corresponding to the first set of symbols. The operations of 908 may be performed in accordance with examples as described herein. In some implementations, aspects of the operations of 908 may be performed by a UE as described with reference to FIG. 5 or a NE as described with reference to FIG. 7.

At 910, the method may include performing detection and estimation on the signal component to recover the information symbols. The operations of 910 may be performed in accordance with examples as described herein. In some implementations, aspects of the operations of 910 may be performed by a UE as described with reference to FIG. 5 or a NE as described with reference to FIG. 7.

It should be noted that the methods described herein describe possible implementations, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A transmitter entity, comprising:
at least one memory; and
at least one processor coupled with the at least one memory and configured to cause the transmitter entity to:
determine a first precoder transform for two sets of symbols;
map the two sets of symbols to an input sequence of symbols corresponding to at least one transmission layer and a set of physical transmission resources;
apply the first precoder transform to the input sequence of symbols by performing a time-domain extension filtering and spreading of the input sequence of symbols onto a set of frequency carriers as the set of physical transmission resources;
modulate the set of frequency carriers using a second transform to generate a waveform signal; and
transmit the waveform signal to a receiver entity.

2. The transmitter entity of claim 1, wherein the first precoder transform is a non-square linear transform, wherein inputs to the non-square linear transform include a number of time-domain samples that is greater than a number of spread frequency-domain outputs of the non-square linear transform.

3. The transmitter entity of claim 2, wherein the non-square linear transform is based on a truncated Discrete Fourier Transform (DFT) having a first stage and a second stage.

4. The transmitter entity of claim 3, wherein the first stage corresponds to spreading input samples to intermediary frequency-domain outputs using a regular square DFT.

5. The transmitter entity of claim 4, wherein the second stage corresponds to a reduction of the intermediary frequency-domain outputs and a rescaling, wherein the reduction of the intermediary frequency-domain outputs is generated by removing a plurality of samples from the intermediary frequency-domain outputs.

6. The transmitter entity of claim 1, wherein the second transform corresponds to an Inverse Fast Fourier Transform (IFFT) of an Orthogonal Frequency Domain Multiplexing (OFDM) modulator.

7. The transmitter entity of claim 1, wherein a second set of symbols of the two sets of symbols is generated to reduce a Peak-to-Average Power Ratio (PAPR) metric of the waveform signal as PAPR reduction symbols.

8. The transmitter entity of claim 1, wherein a second set of symbols of the two sets of symbols comprises one of a fixed sequence of symbols and a dynamically-generated sequence of symbols based on the first set of symbols.

9. The transmitter entity of claim 8, wherein the dynamically-generated sequence of symbols is based on the first set of symbols comprising at least one of:
a subset of the first set of symbols;
a conjugation of the subset of the first set of symbols;
a mirroring of the subset of the first set of symbols, wherein the mirroring is performed against in-phase and quadrature components of the subset of the first set of symbols;
a linear combination of the subset of the first set of symbols; and
a non-linear combination of the subset of the first set of symbols.

10. The transmitter entity of claim 8, wherein the input sequence of symbols comprises at least one of:
the second set of symbols being pre-pended to the first set of symbols;
the second set of symbols being appended to the first set of symbols;
a subset of the second set of symbols being pre-pended to the first set of symbols and a reminder subset of the second set of symbols being appended to the first set of symbols; and
interleaving the first set of symbols and the second set of symbols.

11. The transmitter entity of claim 1, wherein the two sets of symbols are each sampled from two discrete constellation alphabets.

12. The transmitter entity of claim 1, wherein the waveform signal further comprises control information signaling indications of a transmitter configuration comprising at least one of:
generation of a second set of symbols of the two sets of symbols;
the determined first precoder transform; and
a mapping pattern corresponding to the input sequence of symbols in relation to the first set of symbols and the second set of symbols.

13. A method performed by a transmitter entity, the method comprising:
determining a first precoder transform for two sets of symbols;
mapping the two sets of symbols to an input sequence of symbols corresponding to at least one transmission layer and a set of physical transmission resources;
applying the first precoder transform to the input sequence of symbols by performing a time-domain extension filtering and spreading of the input sequence of symbols onto a set of frequency carriers as the set of physical transmission resources;
modulating the set of frequency carriers using a second transform to generate a waveform signal; and
transmitting the waveform signal to a receiver entity.

14. A receiver entity, comprising:
at least one memory; and
at least one processor coupled with the at least one memory and configured to cause the receiver entity to:
receive a waveform signal from a transmitter entity, wherein the waveform signal corresponds to two sets of symbols arranged in an input sequence of symbols, and wherein a first set of symbols of the two sets of symbols is generated by an information source as information symbols;
demodulate the waveform signal to frequency-domain samples using a third transform and equalizing transmission effects of the frequency-domain samples;
receive a configuration comprising information of at least a first transform and a second set of symbols of the two sets of symbols, wherein the first transform corresponds to a first precoder transform applied at the transmitter as a non-square linear transform, and the non-square linear transform takes as inputs a number of time-domain samples larger than the number of spread frequency-domain outputs;
apply the configuration information to cancel from the first set of symbols residual interference of a signal component corresponding to the second set of symbols and to generate a signal component corresponding to the first set of symbols; and
perform detection and estimation on the signal component to recover the information symbols.

15. The receiver entity of claim 14, wherein a third transform corresponds to a Fast Fourier Transform (FFT) of an Orthogonal Frequency Domain Multiplexing (OFDM) demodulator.

16. The receiver entity of claim 14, wherein the second set of symbols of the two sets of symbols is generated to reduce Peak-to-Average Power Ratio (PAPR) metric of a waveform signal as PAPR reduction symbols.

17. The receiver entity of claim 14, wherein the second set of symbols of the two sets of symbols comprises one of a fixed sequence of symbols and a dynamically-generated sequence of symbols based on a first set of symbols of the two sets of symbols.

18. The receiver entity of claim 14, wherein configuration information elements comprise at least one of:
an indication of a precoder type associated with a first transform;
an indication of one or more precoder dimension associated with the first transform;
an indication of a truncated Discrete Fourier Transform (DFT) associated with the first transform, wherein the indication further comprises at least one of one or more removed DFT rows from a regular square DFT and of size of the regular square DFT; and
an indication of the type of the second set of symbols of the two sets of symbols, wherein the indication further comprises at least one of:
a fixed sequence of symbols used to generate the second set of symbols;
a mapping used to generate the second set of symbols based on the first set of symbols of the two sets of symbols; and
an arrangement of the second set of symbols in the input sequence of symbols.

19. The receiver entity of claim 14, wherein the first precoder transform performs a time-domain extension filtering and spreading of an input sequence of symbols onto a set of frequency carriers as a set of physical transmission resources.

20. A method performed by a receiver entity, the method comprising:
receiving a waveform signal from a transmitter entity, wherein the waveform signal corresponds to two sets of symbols arranged in an input sequence of symbols, and wherein a first set of symbols of the two sets of symbols is generated by an information source as information symbols;
demodulating the waveform signal to frequency-domain samples using a third transform and equalizing transmission effects of the frequency-domain samples;
receiving a configuration comprising information of at least a first transform and a second set of symbols of the two sets of symbols, wherein the first transform corresponds to a first precoder transform applied at the transmitter as a non-square linear transform, and the non-square linear transform takes as inputs a number of time-domain samples larger than the number of spread frequency-domain outputs;
applying the configuration information to cancel from the first set of symbols residual interference of a signal component corresponding to the second set of symbols and to generate a signal component corresponding to the first set of symbols; and
performing detection and estimation on the signal component to recover the information symbols.
